(19) United States
(12) Patent Application Publication
(10) Pub. No.: US 2021/0386100 A1
(43) Pub. Date: Dec. 16, 2021

(54) A CONTINUOUS FREEZE DRYER, HOPPER AND METHOD OF FREEZE-DRYING

(71) Applicant: Freeze Dried Foods New Zealand Limited, Hastings (NZ)

(72) Inventors: Alastair James Woodburn GASS, Napier (NZ); Austen Frank CHITTOCK, Havelock North (NZ); Brian Donald EDWARDS, Maraekakaho, Hastings (NZ)

(73) Assignee: Freeze Dried Foods New Zealand Limited, Hastings (NZ)

(21) Appl. No.: 17/289,505

(22) PCT Filed: Oct. 10, 2019
(86) PCT No.: PCT/NZ2019/050133

§ 371 Date: Apr. 28, 2021

(30) Foreign Application Priority Data
Oct. 29, 2018 (NZ) 747776

(51) Int. Cl. A23L 3/00; A23L 3/44

(52) U.S. Cl. CPC A23L 3/001; A23V 2002/00; A23L 3/44

(57) ABSTRACT

A continuous freeze dryer having a hopper for supplying product to the inlet of the freeze-drying chamber via a sealed coupling with the inlet. A hopper valve allows the hopper to be sealed and evacuated with a product to be freeze-dried inside. An inlet valve of the freeze-drying chamber and a hopper valve may both be opened to provide a pathway between the hopper and the chamber whilst the hopper and chamber are maintained in an evacuated condition. The hopper may include an internal shell within an external shell with an evacuation port for evacuation a cavity between the shells. A hopper valve allows the supply of product to the freeze dryer via a hopper port. Product may be loaded into a hopper, coupled with the inlet of the freeze-drying chamber, evacuated, a hopper valve opened to supply product to the freeze-drying chamber, and the product conveyed through the freeze-drying chamber.

### FIELD

This invention relates to a continuous freeze dryer, a hopper for supplying product to the freeze dryer and a method of freeze-drying.

### BACKGROUND

Products, such as food products, may be dried using pure drying systems, which operate at atmospheric pressure and remove moisture by evaporation using heat, or freeze dryers, which operate by freezing a product, lowering the pressure in a vessel, and then removing the ice by sublimation. Current freeze drying machines largely fall into the categories of small batch dryers or large and expensive “continuous” dryers.

Small batch dryers consist of a single vessel into which product is loaded, the dryer is closed and evacuated and temperature is cycled through the drying process. These systems have limited throughput, require a high amount of labour and have relatively high processing costs on a cost per weight of product basis.

Large continuous dryers typically have a first stage into which trays are manually loaded, with the first stage then being evacuated before the trays pass to subsequent stages for progressive heating (from high temperature to lower temperature) under reduced pressure conditions. The throughput of such systems is limited by the need to pressurise/load/depressurise for each new load of product input to the dryer. Such machines have a large footprint due to the number of sequential processing stages employed. They also have relatively high energy requirements and labour input costs for the loading and unloading of trays and opening and closing of the different stages. They also require a relatively large volume to be evacuated during repeated pressurisation and depressurization cycles. Many also employ inefficient fluid heating systems. This can result in high plant costs and high operating costs for a given processing capacity.

It is an object of the invention to provide an improved freeze dryer, hopper and method of freeze drying or to at least provide the public with a useful choice.

### SUMMARY

According to one example embodiment there is provided a continuous freeze dryer comprising:
a. freeze-drying chamber capable of at least partial evacuation having a continuous conveyor from an inlet to an outlet, wherein the inlet has an inlet valve; and
b. a hopper for supplying product to the inlet of the freeze-drying chamber configured to form a sealed coupling with the inlet, wherein the hopper includes a hopper valve allowing the hopper to be sealed and evacuated with a product to be freeze-dried inside,
wherein, when the hopper is coupled to the chamber, the inlet valve and hopper valve may both be opened to provide a pathway between the hopper and the chamber whilst the hopper and chamber are maintained in an evacuated condition.

According to another example embodiment there is provided a hopper for supplying product to a freeze dryer inlet including:
a. an external shell;
b. an internal shell within the external shell defining a cavity between the shells and including openings in the internal shell creating a fluid transfer path between the interior of the internal shell and the cavity;
c. a product port for coupling to an inlet of a freeze dryer to provide
d. an evacuation port for evacuation of the cavity; and
e. a hopper valve for opening and closing the product port.

According to a further example embodiment there is provided a continuous freeze-drying method comprising the steps of:
a. providing an evacuated freeze-drying chamber having an inlet and an outlet;
b. loading product into a hopper;
c. coupling the hopper with the inlet of the freeze-drying chamber;
d. evacuating the hopper;
e. opening a pathway between the hopper and the inlet to allow product to enter the evacuated freeze-drying chamber; and
f. conveying the product through and freeze drying the product in the freeze-drying chamber.

It is acknowledged that the terms “comprise”, “comprises” and “comprising” may, under varying jurisdictions, be attributed with either an exclusive or an inclusive meaning. For the purpose of this specification, and unless otherwise noted, these terms are intended to have an inclusive meaning—i.e., they will be taken to mean an inclusion of the listed components which the use directly references, and possibly also of other non-specified components or elements.

Reference to any document in this specification does not constitute an admission that it is prior art, validly combinable with other documents or that it forms part of the common general knowledge.

### BRIEF DESCRIPTION OF THE DRAWINGS

The accompanying drawings which are incorporated in and constitute part of the specification, illustrate embodiments of the invention and, together with the general description of the invention given above, and the detailed description of embodiments given below, serve to explain the principles of the invention, in which:

FIG. 1 is a cross-sectional side view of a freeze dryer supplied with product by a hopper;

FIG. 2 is a cross-section top view of the freeze dryer shown in FIG. 1;

FIG. 3 is a cross-sectional side view of a hopper positioned above a freeze dryer inlet prior to coupling;

FIG. 4 is a cross-sectional side view of a hopper coupled to a freeze dryer inlet;

FIG. 5 is a cross-sectional side view of a hopper coupled to a freeze dryer inlet with the freeze dryer inlet valve open; and

FIG. 6 is a cross-sectional side view of a hopper coupled to a freeze dryer inlet with the freeze dryer inlet valve and hopper cone valve open.

### DETAILED DESCRIPTION

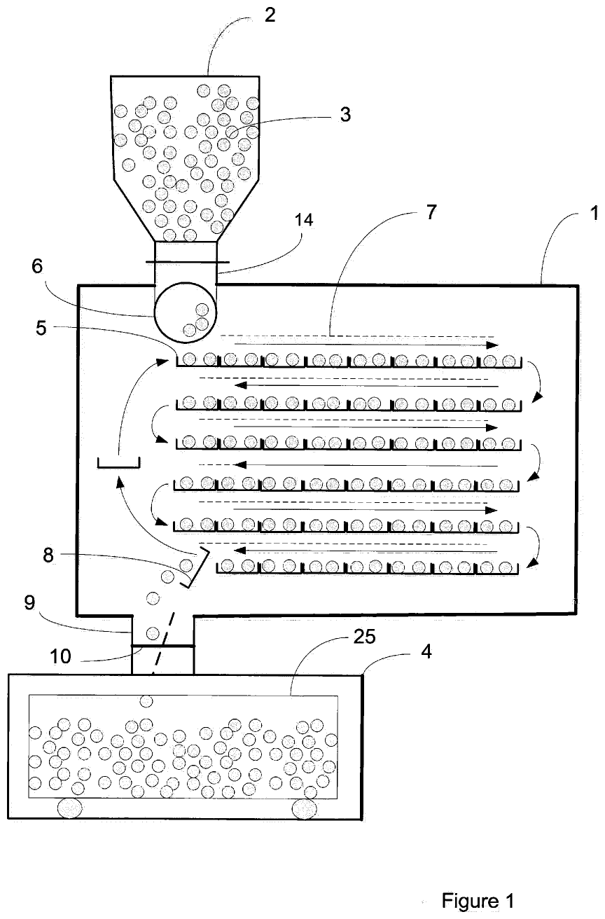

FIG. 1 illustrates a freeze dryer including a chamber 1 with a hopper 2 coupled to it to supply a product 3 to the freeze dryer and a receptacle 4 for receiving processed product. Product entering the freeze dryer is distributed onto a tray 5 by a rotary feeder 6 as the tray passes under it. A number of trays are provided on each level depending upon the size of the chamber. The trays are sequentially moved from the top to the bottom as illustrated by the arrows and at the bottom the tray 8 is tipped to release product via outlet 9 into receptacle 4 when butterfly valve 10 is open. Tray 8 is then moved to the top tray position (tray 5). Radiating elements 7, in this case in the form of electrical resistances elements, are provided above each tray to heat the product on each tray. Heating is controlled to decrease heating from the top tray to the bottom tray as the product heats and moisture is removed from the product.

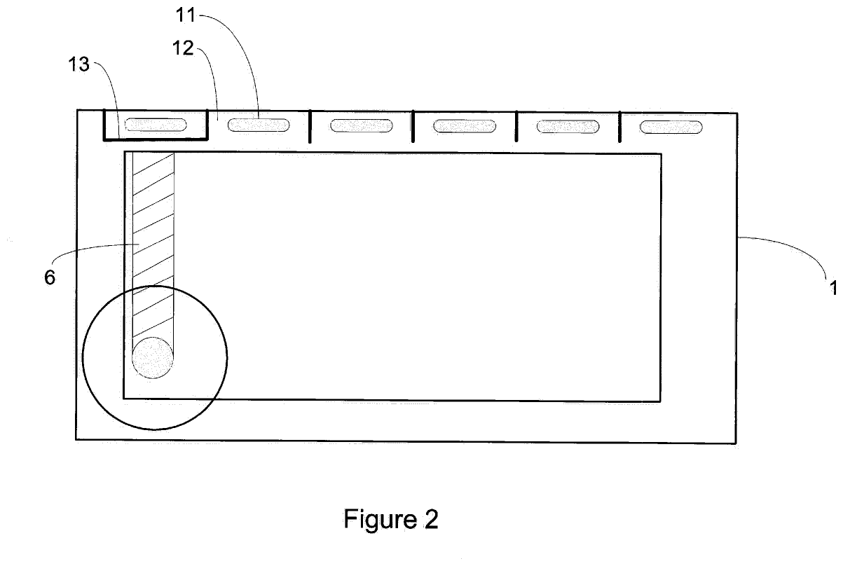

Referring now to the top view of the freeze dryer in FIG. 2 it will be seen that a number of condensers 11 are provided in bays 12 within chamber 1. The condensers trap water vapour removed from the product as ice which must be periodically removed, typically when a layer of ice about 3-5 mm thick forms on the surface of a condenser. A screen 13 moves across a bay 12 during defrosting. The condenser is then heated and condensate and defrost water is then conveyed out of the chamber. After defrosting a condenser, the screen 13 may be moved to the next bay 12 to defrost the next condenser.

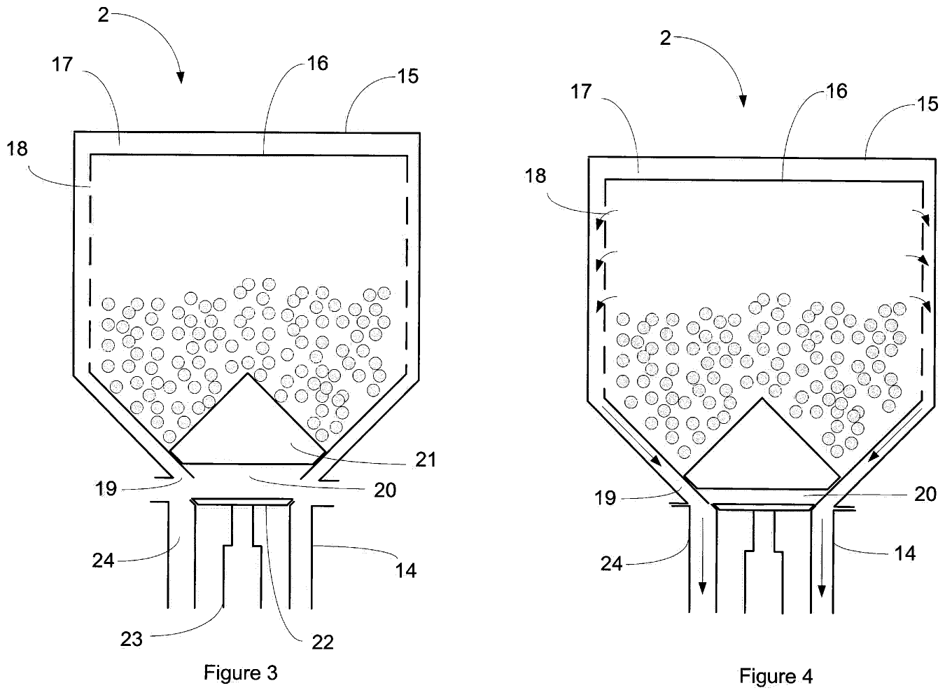

Referring to FIG. 3 a side cross-sectional view of the hopper 2 and chamber inlet 14 are shown. All components have circular horizontal cross sections. The hopper 2 is seen to be formed by an external shell 15 supporting a spaced apart internal shell 16 defining a cavity 17 between the walls of the shells. The double wall construction provides insulation between the frozen product within the hopper and the external ambient temperature, reducing frosting and condensation, which may pose a biological hazard. An opening at one end of the inner shell forms a product port 20 for supplying product to the chamber inlet 14. The inner shell 16 has a number of openings 18 (enlarged for illustration) creating a fluid transfer path between the interior of the internal shell 16 and the cavity 17. An annular opening 19 forms an evacuation port for evacuation of fluid from the hopper—fluid within internal shell 16 passes through openings 18 to the cavity 17 and then out through the annular opening 19 to evacuation port 24. A hopper valve in the form of cone valve 21 is provided which may be closed to retain product within the hopper or opened to allow product to flow into the chamber inlet 14.

The chamber inlet 14 includes an inlet valve 22 that may be raised and lowered by a linear actuator, in this case a ram 23. In the closed position inlet valve 22 provides an airtight seal to chamber 1. In the open position inlet valve 22 is raised (into the hopper) a sufficient height to allow product to flow from the hopper 2 into the chamber inlet 14.

The sequence of steps for coupling the hopper to the chamber inlet, evacuating the hopper, opening the valves to supply product to the chamber inlet, closing the valves and decoupling the hopper will be described with regard to FIGS. 3 to 6.

FIG. 3 shows the chamber inlet 14 sealed by inlet valve 22 with the hopper 2 positioned above and apart from hopper 2. Hopper 2 has been previously loaded with frozen product and cone valve 21 closed. Hopper 2 is then lowered onto inlet 14 and coupled thereto as shown in FIG. 4. Hopper 2 is coupled to the inlet 14 so that annular opening 19 is aligned with evacuation port 24 and product port 20 is aligned with the product inlet 14.

The hopper is then evacuated via evacuation port 24 which draws fluid within internal shell 16 through openings 18 to the intermediate cavity 17 and then out through the annular opening 19 to evacuation port 24. The hopper may be evacuated to a pressure close to or the same as the pressure within the chamber, preferably 2 mbar or less. This ensures that there is no significant variation of the conditions within the chamber 1 during loading which may adversely affect product processing and also minimizes the energy required and handling.

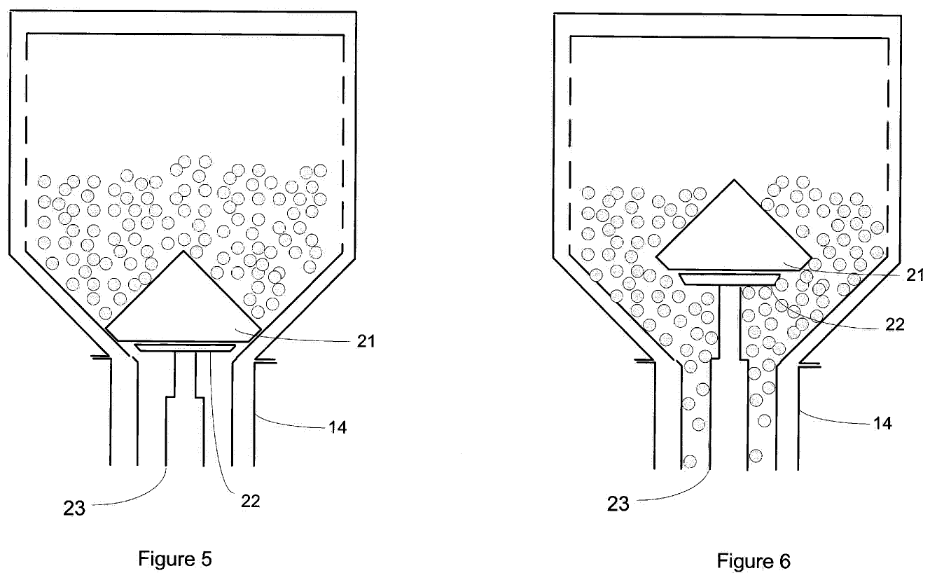

Next the linear actuator 23 is extended to initially open the inlet valve 22 as shown in FIG. 5. The liner actuator is further extended to the position shown in FIG. 6 to open the cone valve 21 too and is raised high enough allow product to be supplied to the freeze dryer via the chamber inlet 14.

Once the product has been supplied to the freeze dryer linear actuator 23 is retracted back to the position shown in FIG. 4 to close both the cone valve 21 and the inlet valve 22. The hopper is then repressurised by supplying air via evacuation port 24 through annular opening 19 to cavity 17 and into internal shell 16 through openings 18. The hopper may then be decoupled and removed. This facilitates simple loading via a number of hoppers with minimal handling and without the need to pressurize and depressurize the main chamber.

Referring again to FIG. 1 product supplied via inlet 14 is evenly distributed by feeder 6 over the top tray. The chamber is at least partially evacuated in use, preferably to 2 mbar or less. Each tray is heated by radiating elements 7 positioned above the trays of each level to provide required heating. The radiating elements are controlled to create a temperature gradient that decreases from the top to the bottom of the chamber 1. The trays are continuously moved down from the top to the bottom. When the bottom tray 8 is ready to be emptied it is tilted so that product may be supplied to the chamber outlet 9. Once free of product the bottom tray 8 moves to the top to become the new top tray 5. Whilst a series of trays are shown an alternative form of conveyor may be employed to convey the product from the inlet to the outlet through the chamber.

As product passes through the chamber moisture is removed due to the radiating elements 7 sublimating the ice to gas and the condensers removing the water vapour. The heat provided by the radiating elements 7 decreases along the processing path as the temperature of the product rises and moisture is removed.

At the outlet 9 a receptacle 4 is coupled to outlet 9 and evacuated to a pressure of about 2 mbar. Butterfly valve is then opened (the position shown in dashed line) so that product supplied from the bottom tray 8 may pass through outlet 9 into receptacle 4. A trolley 25 may be provided within the receptacle to collect processed product and when the trolley 25 is full butterfly valve 10 may be closed, the receptacle 4 repressurised, a door of the receptacle 4 opened and trolley 25 removed and replaced with an empty trolley.

This plant and process provides the following advantages:
1. High throughput—continuous operation avoids delays in pressurising/unloading/loading/depressurising each load.
2. Compact footprint—multilayer trays in one chamber take up much less space than sequential processing stages.
3. Low labour input—simple hopper loading instead of loading and unloading trays and opening and closing stages. A traditional large processing plant may require up to 5 times as many operators for the same throughput
4. Less energy:
   a. Smaller volume to evacuate and avoidance of repeated pressurisation and depressurisation.
   b. Direct IR heating instead of inefficient fluid heating.
   c. Constant refrigeration loads.
5. Cost—the compact design makes the freeze dryer much less expensive to produce
6. Scalability—the design may be made to any scale and provides solutions falling between the traditional batch and continuous dryers presently available.

While the present invention has been illustrated by the description of the embodiments thereof, and while the embodiments have been described in detail, it is not the intention of the applicant to restrict or in any way limit the scope of the appended claims to such detail. Additional advantages and modifications will readily appear to those skilled in the art. Therefore, the invention in its broader aspects is not limited to the specific details, representative apparatus and method, and illustrative examples shown and described. Accordingly, departures may be made from such details without departure from the spirit or scope of the applicant's general inventive concept.

1. A continuous freeze dryer comprising:
a. a freeze-drying chamber capable of at least partial evacuation having a continuous conveyor from an inlet to an outlet, wherein the inlet has an inlet valve; and
b. a hopper for supplying product to the inlet of the freeze-drying chamber configured to form a sealed coupling with the inlet, wherein the hopper includes a hopper valve allowing the hopper to be sealed and evacuated with a product to be freeze-dried inside,
wherein, when the hopper is coupled to the chamber, the inlet valve and hopper valve may both be opened to provide a pathway between the hopper and the chamber whilst the hopper and chamber are maintained in an evacuated condition.

2. A continuous freeze dryer as claimed in claim 1 wherein an evacuation port is coupled to the hopper when the hopper is coupled to the freeze dryer inlet to facilitate evacuation of the hopper.

3. A continuous freeze dryer as claimed in claim 2 wherein the hopper is of dual wall construction having spaced apart inner and outer walls with passages between the volume between the walls and the interior of the hopper.

4. A continuous freeze dryer as claimed in claim 3 wherein the evacuation port is coupled to the volume between the walls of the hopper.

5. A continuous freeze dryer as claimed in claim 1 wherein the hopper valve is a cone valve.

6. A continuous freeze dryer as claimed in claim 1 wherein a linear actuator is extended to open the inlet valve and hopper valve.

7. A continuous freeze dryer as claimed in claim 1 including a plurality of stacked trays which move sequentially from the top to the bottom of the chamber during freeze-drying.

8. A continuous freeze dryer as claimed in claim 7 wherein the bottom tray is tipped to deliver processed product to the chamber outlet and then positioned as the top tray.

9. A continuous freeze dryer as claimed in claim 7 including a feeder which distributes product evenly across the top tray.

10. A continuous freeze dryer as claimed in claim 7 including radiating elements positioned above the trays of each level to provide required heating.

11. A continuous freeze dryer as claimed in 10 wherein the radiating elements are controlled to create a temperature gradient that decreases from the top to the bottom.

12. A continuous freeze dryer as claimed in claim 7 including a plurality of condensers within the chamber to remove moisture from the chamber.

13. A continuous freeze dryer as claimed in claim 12 wherein each condenser is located in a bay that may be selectively isolated for defrosting.

14. A continuous freeze dryer as claimed in claim 13 wherein each condenser is sequentially isolated by a screen that sequentially moves across to seal each bay.

15. A continuous freeze dryer as claimed in claim 7 wherein the outlet includes a butterfly valve to control the flow of product via the outlet.

16. A hopper for supplying product to a freeze dryer inlet including:
a. an external shell;
b. an internal shell within the external shell defining a cavity between the shells and including openings in the internal shell creating a fluid transfer path between the interior of the internal shell and the cavity;
c. a product port for coupling to an inlet of a freeze dryer to provide a conduit for the supply of product to the freeze dryer;
d. an evacuation port for evacuation of the cavity; and
e. a hopper valve for opening and closing the product port.

17. A hopper as claimed in claim 16 wherein the evacuation port forms a sealed coupling with an evacuation conduit as the product port couples with the freeze dryer inlet.

18. A hopper as claimed in claim 17 wherein the evacuation port surrounds the product port.

19. A hopper as claimed in claim 18 wherein the evacuation port is an annular port.

20. A hopper as claimed in claim 16 wherein the hopper valve is a cone valve.

21. A continuous freeze-drying method comprising the steps of:
a. providing an evacuated freeze-drying chamber having an inlet and an outlet;
b. loading product into a hopper;
c. coupling the hopper with the inlet of the freeze-drying chamber;
d. evacuating the hopper;
e. opening a pathway between the hopper and the inlet to allow product to enter the evacuated freeze-drying chamber; and
f. conveying the product through and freeze-drying the product in the freeze-drying chamber.

22. A continuous freeze-drying method as claimed in claim 21 comprising the further steps of:
a. coupling an evacuated receptacle to the outlet and opening a pathway between the freeze-drying chamber outlet and the receptacle; and
b. transferring processed product to the receptacle through the outlet.

23. A method as claimed in claim 21 wherein the inlet includes an inlet valve and the hopper includes a hopper valve and both valves are opened to create a pathway between the hopper and the inlet.

24. A method as claimed in claim 23 wherein the inlet valve and hopper valve are opened and closed by a linear actuator.

25. A method as claimed in claim 21 wherein after product is supplied to the inlet the pathway between the freeze-drying chamber outlet and the receptacle is closed, the hopper is repressurised to atmospheric pressure and the hopper is removed.

26. A method as claimed in claim 21 wherein the product is heated according to a reducing temperature profile from the inlet to the outlet.

27. A method as claimed in claim 21 wherein the pressure in the chamber is maintained below 2 mbar.
